(19) United States
(12) Patent Application Publication
(10) Pub. No.: US 2026/0087945 A1
(43) Pub. Date: Mar. 26, 2026

(54) SURGICAL SIMULATION SYSTEMS AND METHODS WITH SELECTIVE PERFUSION

(71) Applicant: MAXIMUM FIDELITY SURGICAL SIMULATIONS, INC., ST. LOUIS, MO (US)

(72) Inventor: JOSS DEAN FERNANDEZ, Columbia, MO (US)

(21) Appl. No.: 19/199,149

(22) Filed: May 5, 2025

Related U.S. Application Data
(60) Provisional application No. 63/642,479, filed on May 3, 2024.
(60) Provisional application No. 63/776,456, filed on Mar. 24, 2025.

(51) Int. Cl. G09B 23/30; A01N 1/00

(52) U.S. Cl. CPC G09B 23/303; A01N 1/00; G09B 23/306

(57) ABSTRACT

Systems and methods for selectively perfusing cadaverous organ systems for surgical simulation are provided. A first fluid reservoir contains a first perfusion fluid and fluidically connects to conduit, which fluidically connects to a first body part associated with the organ system. A pump fluidically connects to the first reservoir and conduit and directs the first perfusion fluid into the first body part. A second fluid reservoir contains a second perfusion fluid and fluidically connects to conduit, which fluidically connects to a second body part associated with the organ system. In aspects, the second fluid reservoir is positioned at higher elevation than the organ system to create passive feed pressure of the second perfusion fluid to the second body part. The systems may include drainage mechanisms from the organ system. Aspects include selective perfusion of the liver, thorax, head and neck, and/or extremities of a cadaver.

### CROSS-REFERENCE TO RELATED APPLICATIONS

This application claims priority pursuant to 35 U.S.C. § 119(e) to co-pending U.S. Provisional Patent Application Ser. No. 63/642,479, filed May 3, 2024, and further claims priority pursuant to 35 U.S.C. § 119(e) to co-pending U.S. Provisional Patent Application Ser. No. 63/776,456, filed Mar. 24, 2025, the entireties of which are incorporated herein by reference.

### FIELD OF THE INVENTION

The present invention relates generally to medical simulations. More specifically, the present invention is concerned with systems and methods for cannulation of organ systems of human cadavers for surgical simulations.

### BACKGROUND OF THE INVENTION

Surgical simulations are an integral part of education for medical students. Moreover, realistic medical simulations are important for testing and/or practicing new surgical techniques and/or new medical devices.

Among other disadvantages, completely synthetic surgical simulations and surgical procedures on animal subjects are not fully realistic of surgical procedures on a live human subject. Accordingly, it would be beneficial to have systems and methods for realistic surgical simulations.

To simulate live human conditions more accurately, circulatory systems of human cadavers have been reconstituted and simulated blood fluid or real blood is perfused therethrough. Examples of such systems and methods are described within U.S. Pat. Nos. 10,235,906; 10,825,360; 11,410,576; 11,716,989; and 11,915,610, the entireties of each are incorporated herein by reference. Nevertheless, such systems and methods are limited to use with a cadaver with a relatively complete circulatory system intact, limiting the ability to use cadavers in which significant portions of tissue have been donated. Accordingly, it would be beneficial to have efficient and accurate surgical and medical simulations directed to specific organ systems.

Isolation and perfusion of cadaverous vasculature only associated with specific organs or organ systems comes with unique challenges for each specific organ or organ system. For one example, liver anatomy poses intricate challenges for surgical simulations because, among other issues, it includes three distinct areas requiring perfusion, each of which is potentially prone to bleeding. Other specific organs and organ systems create similarly complex challenges.

Nevertheless, completely synthetic simulations and/or animal models are often inadequate for truly simulating human surgical conditions. As an example, conducting thoracic surgery necessitates precise management of the pulmonary artery and venous system, a complexity which is very difficult to replicate either synthetically or in animal models. Additionally, for robot or thoracoscopic assisted surgery simulations, it is important to mimic the chest cavity shape and size for a human because it is very important to have correct positioning of incisions and thoracoscopic trocars. Other organ system specific surgeries have similar human-specific complexities which necessitate effective medical training therefor.

Accordingly, it would be beneficial to have systems and methods available for effective surgical simulations for specific organs and organ systems which maximize usability of donated cadaverous tissues while providing anatomically-accurate simulation scenarios.

Heretofore there has not been available a system or method for selective perfusion or cannulation of cadaver organ systems for surgical simulation with the advantages and features of the present invention.

### SUMMARY OF THE INVENTION

The present invention comprises novel systems and methods for connecting a fluid circuit in cadaveric tissue to assist in revitalizing specific organ systems. Utilization of the present invention to revitalize such specific organ systems helps to maximize the use of donated tissue without the need to discard the entire cadaver body, allowing for further use in medical simulation.

The present invention represents a groundbreaking development in surgical simulation technology, including, but not limited to, in the context of simulating liver, thoracic, head, neck, arm, and/or leg procedures. Exemplary embodiments of the present invention comprise selective perfusion and cannulation techniques and systems, providing a level of realism and precision previously unattainable in surgical simulation environments. Exemplary embodiments of the present invention comprise selective perfusion and cannulation of specific organ systems, departing from prior methods of inlet and egress for cadaveric tissue.

In embodiments, the present invention includes synthetic components configured for fluidic connection to cadaveric tissue in association with and/or in proximity to one or more organ systems of a cadaver, or a portion of a cadaver, to accurately simulate surgical procedures on a live human subject. In embodiments, the system of the present invention includes a series of conduits, or tubing, fluidically connected to a cadaveric body part via one or more cannula or alternative connector(s) and further fluidically connected, either directly or indirectly, to one or more fluid reservoir. In embodiments, the system of the present invention is configured for being pressurized and for perfusing one or more perfusion fluid through one or more cadaveric organ systems to simulate live human conditions.

In embodiments, one or more perfusion fluid comprises actual or simulated blood fluid. In an exemplary embodiment, the present system utilizes an oxygenated actual or simulated blood fluid and a deoxygenated actual or simulated blood fluid. In embodiments, a first fluid reservoir contains oxygenated perfusion fluid and a second fluid reservoir contains deoxygenated perfusion fluid. In an exemplary embodiment of the present invention, one or more fluid reservoir and conduit(s) are configured to fluidically connect and supply an oxygenated perfusion fluid to a first cadaveric blood vessel or alternative cadaveric body part in proximity to and/or associated with a cadaveric organ or organ system for surgical simulation thereof. In an exemplary embodiment, one or more fluid reservoir and conduit(s) are configured to fluidically connect and supply a deoxygenated perfusion fluid to a second cadaveric blood vessel or alternative cadaveric body part in proximity to and/or associated with a cadaveric organ or organ system for surgical simulation thereof.

In an exemplary embodiment, one or more fluid reservoir and associated conduit(s) are further fluidically connected to one or more pump in line with the conduit(s) and configured for pumping perfusion fluid from the one or more fluid reservoir through the associated conduit(s) and into a fluidically connected cadaveric blood vessel or alternative cadaveric body part in proximity to and/or associated with a cadaveric organ or organ system. In embodiments, each pump of the present invention may be a pulsatile pump or a non-pulsatile pump. In an exemplary embodiment, one or more fluid circuit of the present invention is configured to be pressurized so as to accurately simulate blood pressure within blood vessels and organ systems in a live human subject. In embodiments, the present system is further equipped with pressure gauges, adjustable pressure controls, and release valves for monitoring and controlling pressure within the system.

In some embodiments of the present invention, pressure “Y” adapters are utilized in fluidic connection to cannulas connected to arteries, enabling controlled pressurization of the organism followed by pressure release. In exemplary embodiments, the present cannulation systems and methods are designed to prevent organism over pressurization and to facilitate adjustments in back pressure as needed.

In exemplary embodiments, the pressurization of venous cannulas is achieved through adjustments of the height of a fluid reservoir relative to the cannulated vein or a pressure-control pump.

In embodiments, other cadaverous blood vessels which are not to be utilized for surgical simulation are ligated, clamped, or otherwise closed off. In some embodiments, one or more drain is utilized for collecting perfusion fluid perfused through the cadaveric organ or organ system. In some embodiments utilizing a drain, perfusion fluid collected by the drain is redirected via conduit(s) or tubing to a fluid reservoir, which may or may not allow for reuse of the perfusion fluid as part of the surgical simulation.

In embodiments, the present system further utilizes a molded base to collect harvested fluid, which in some embodiments, is subsequently returned to the reservoir, such as, but not limited to, via a pump, such as, but not limited to, an impeller pump.

In exemplary embodiments, the most crucial anatomical relationships are preserved during organ harvesting to accommodate use of cannulation methods of the present invention. For a non-limiting example, the chest cavity is preserved for lung models and the neck is preserved for head models.

In some embodiments of the present invention, synthetic blood vessels are utilized as part of the fluid circuit to simulate blood flow to and from multiple body parts or organ systems.

In exemplary embodiments, the present invention comprises systems and methods for selective perfusion and/or cannulation of a liver organ system to accommodate surgical simulation with a liver resection and transplant model. Such embodiments address the complex issues associated with specifically isolating the circulatory system of the liver for selective perfusion for accurate surgical simulation.

In exemplary embodiments, the present invention comprises systems and methods for selective perfusion and/or cannulation of the pulmonary artery and venous system to accommodate surgical simulation with a thoracic surgery model. Such embodiments address the complex issues associated with specifically isolating the circulatory system of the human thorax for selective perfusion for accurate surgical simulation.

In exemplary embodiments, the present invention comprises systems and methods for selective perfusion and/or cannulation of the circulatory system of the head and neck to accommodate surgical simulation with a head and neck model. Such embodiments address the complex issues associated with specifically isolating the circulatory system of the head and neck for selective perfusion for accurate surgical simulation.

In exemplary embodiments, the present invention comprises systems and methods for selective perfusion and/or cannulation of the circulatory system of one or more human extremities to further accommodate surgical simulation. Such embodiments address the complex issues associated with specifically isolating the circulatory system of human extremities for selective perfusion for accurate surgical simulation.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION OF THE DRAWINGS

Embodiments of the present invention are described in detail below with reference to the attached drawing figures, wherein:

FIG. 1 shows a perspective view of a liver surgical simulation system embodying the present invention.

FIG. 2 shows an enlarged, perspective view of a portion of the liver surgical simulation system.

FIG. 3 shows a perspective view of a thoracic surgical simulation system embodying the present invention.

FIG. 4 shows a perspective view of a head and neck surgical simulation system embodying the present invention.

FIG. 5 shows a perspective view of a human extremities surgical simulation system embodying the present invention.

The drawing figures do not limit the present invention to the specific embodiments disclosed and described herein. The drawings are not necessarily to scale, emphasis instead being placed upon illustrating the principles of the invention.

### DETAILED DESCRIPTION

As required, a detailed embodiment of the present invention is disclosed herein; however, it is to be understood that the disclosed embodiments are merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

The present invention comprises selective perfusion and cannulation systems and methods for connecting a fluid circuit in cadaveric tissue to revitalize specific organ systems. In embodiments, perfusion and cannulation systems and methods of the present invention include one or more conduit or tubing fluidically connected to one or more fluid reservoir and fluidically connected to a cadaveric blood vessel or alternative cadaveric body part in proximity to or associated with an organ or organ system. In embodiments, perfusion and cannulation systems of the present invention include a first reservoir and a second reservoir, each having respective, fluidically connected conduits which fluidically connect to a first cadaveric body part and a second cadaveric body part, respectively, each in proximity to and/or associated with an organ or organ system upon which surgical simulation is desired.

In embodiments, the present system is configured to house and supply perfusion fluid to selectively perfuse vasculature associated with a cadaveric organ system. In embodiments, perfusion fluid of the present invention comprises actual human blood, animal blood, simulated blood fluid, or a combination thereof. In an exemplary embodiment, the present system utilizes both an oxygenated actual or simulated blood perfusion fluid and a deoxygenated actual or simulated blood perfusion fluid. In embodiments, a first fluid reservoir contains oxygenated perfusion fluid and a second fluid reservoir contains deoxygenated perfusion fluid. In some embodiments which utilize simulated blood perfusion fluids, the oxygenated blood fluid is red in color and the deoxygenated blood fluid is blue in color to simulate live human blood conditions.

Conduits or tubing of the present system may be made of any material configured for receiving and retaining a perfusion fluid, such as but not limited to polyurethane, silicone, rubber, polyvinyl chloride (PVC), other polymers, or any other material suitable for same. In some embodiments, conduits of the present invention may further include metal, plastic, or collagen components, or any other material suitable to provide additional structure.

Fluid reservoirs of the present invention each define a container configured to receive and retain a volume of perfusion fluid and include one or more sealed, fluidic connection to one or more outflow conduit or tubing of the present system. Fluid reservoirs of the present invention can be any size and/or shape and made of any material suitable for this purpose. Some embodiments of fluid reservoir of the present invention also include one or more sealed, fluidic connection to one or more inflow conduit or tubing of the present system. In embodiments, fluid reservoirs of the present invention incorporate one or more connector valve(s) and/or one or more access opening(s). In some embodiments, fluid reservoirs of the present invention further incorporate a heater to simulate in vivo blood temperature, one or more one-way flow valves, and/or a pressure pump or alternative pressure mechanism.

In exemplary embodiments, one or more fluid reservoir and fluidically connected conduit(s) are further fluidically connected to one or more pump positioned in line with the connected conduit(s). In embodiments, a pump is configured to direct perfusion fluid from a connected fluid reservoir through connected conduit(s) and into a connected cadaverous body part. In some embodiments, the pump is a pulsatile pump configured to provide pulsatile flow of perfusion fluid into the connected cadaverous body part. In other embodiments, the pump utilized is a non-pulsatile pump. In further embodiments, resistance device(s) and/or other means of generating pulsatile and/or non-pulsatile pressures within a fluid circuit of the present invention are utilized. In embodiments, the present system further includes pressure gauge(s), pressure release valve(s), and controls for adjusting pressure and/or other features within the system.

In embodiments of the present invention, conduits or tubing are selectively connected to cadaverous body parts in proximity to or associated with one or more organ system(s) via fluidic connector(s), such as but not limited to cannula(s), polyester graft bridge(s), internal diameter connector(s), and/or any other suitable fluidic connector.

In some embodiments, pressure adapters, such as but not limited to “Y” adapters, are utilized in fluidic connection to cannulas connected to cadaverous body parts, which allows for controlled pressurization and pressure release. In an exemplary embodiment, pressure adapters are utilized with cannulas connected to cadaverous arteries.

In some embodiments, pressurization of some cadaverous body parts is achieved through positioning and/or adjustment of the height of a connected fluid reservoir relative to the cadaverous body part and/or a pressure-control pump. In an exemplary embodiment, cannulas fluidically connected to cadaverous veins are pressurized by positioning and/or adjusting the height of a connected fluid reservoir.

In embodiments, other cadaverous blood vessels which are not to be utilized for surgical simulation are ligated, clamped, or otherwise closed off.

In some embodiments of the present invention, synthetic blood vessels and/or other synthetic body parts are utilized as part of the fluid circuit to further provide simulated blood flow to and from multiple body parts or organ systems. In some embodiments, medical device(s) are further utilized in association with surgical simulation scenarios, such as but not limited to use of a ventilator in association with simulations involving the lungs.

In embodiments, the selective perfusion system of the present invention is utilized for selective perfusion of a cadaverous organ, a cadaverous organ system, or a combination of multiple cadaverous organs and/or organ systems.

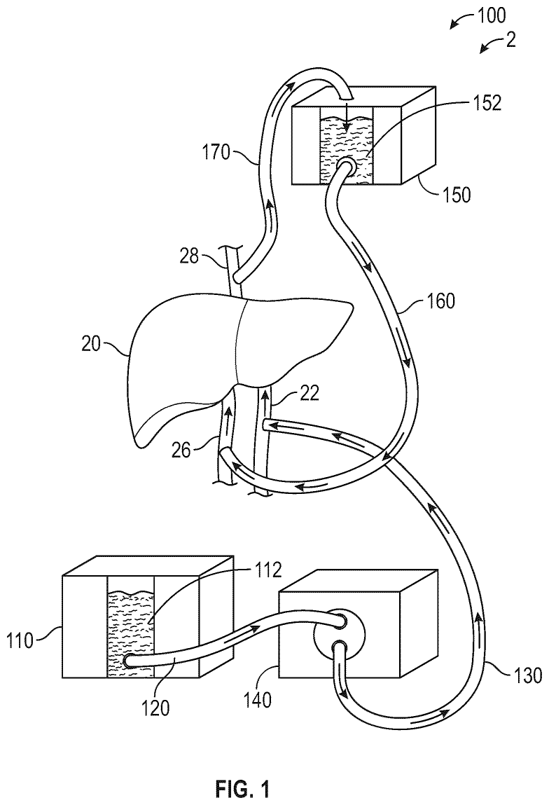

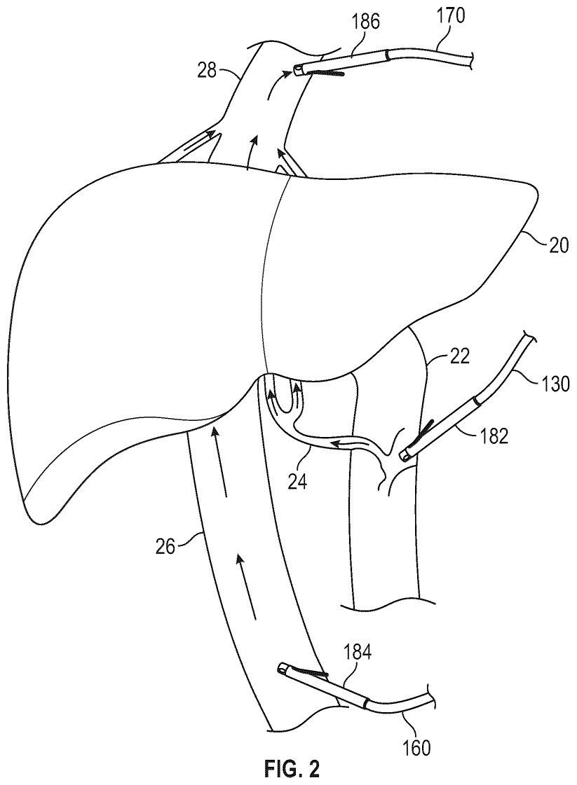

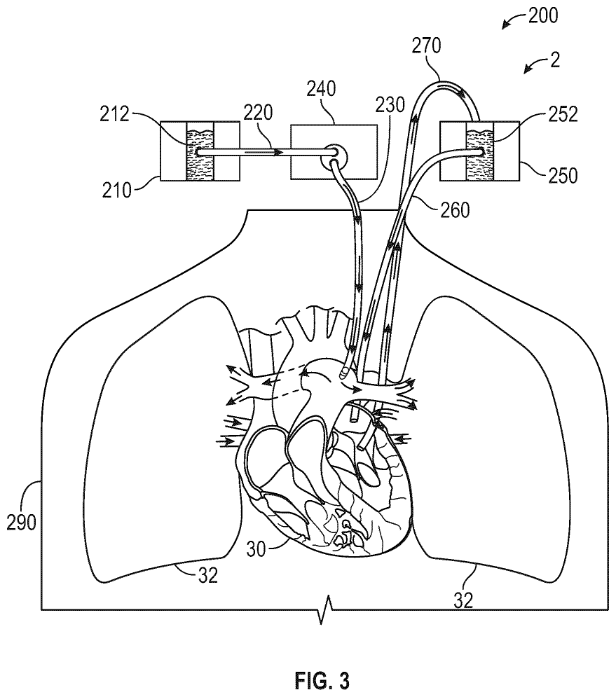

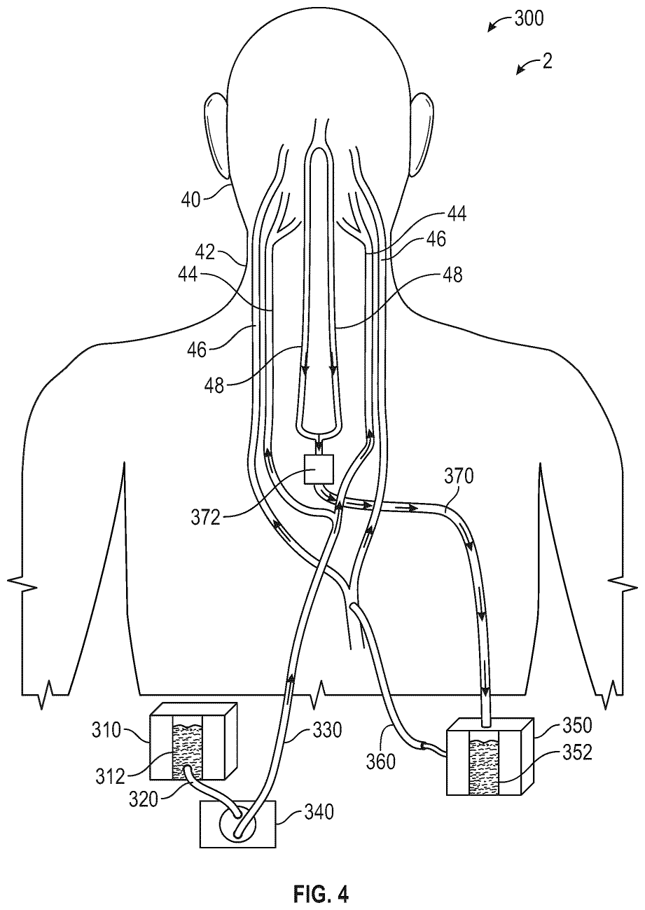

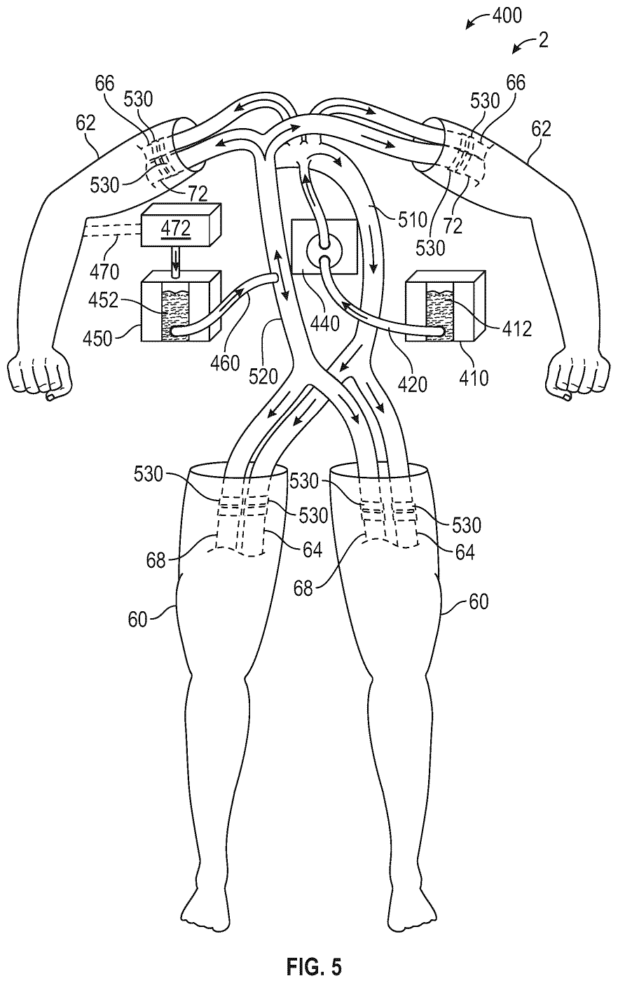

Referring now to the drawings in more detail, FIGS. 1-5 show four exemplary, but non-limiting, embodiments of a perfusion system 2 of the present invention—a liver resection and transplant model 100 (FIGS. 1-2), a thoracic surgery model 200 (FIG. 3), a head and neck model 300 (FIG. 4), and an extremity model 400 (FIG. 5)—are further described herein. While the embodiments specifically described herein are exemplary embodiments of the present invention, such descriptions of these embodiments shall not be interpreted as limiting. Features described in association with one embodiment may be combined with features of one or more other described embodiments in further embodiments of the present invention. Furthermore, embodiments of the present invention may further incorporate feature(s) described within U.S. Pat. Nos. 10,235,906; 10,825,360; 11,410,576; 11,716,989; 11,915,610; or 12,073,737; or U.S. Patent Application Publication Nos. 2024/0156537; 2024/0249646; or 2025/0087116, the entireties of each are incorporated herein by reference.

### Liver Resection and Transplant Model

FIGS. 1 and 2 show an exemplary embodiment of a liver surgical simulation system 100 of the present invention, the embodiment shown in a configuration having a plurality of fluidic connections between the system of the present invention and the cadaveric material. In view of challenges associated with the anatomy of the portion of the human circulatory system associated with the liver 20, this embodiment of the present invention provides selective perfusion and cannulation techniques for precise control over hepatic perfusion.

An embodiment of the present invention includes a liver perfusion and cannulation system 100 wherein hepatic perfusion is regulated through three distinct flow mechanisms—heptic arterial flow, portal venous flow, and heptic venous flow.

In some embodiments, hepatic arterial flow is achieved via pulsatile-pressure perfusion at a first fluidic connection of the system with the cadaveric material. In some embodiments, the first fluidic connection is achieved by cannulation of the aorta, thereby facilitating flow into the cadaveric liver. In some such embodiments, perfusion of the aorta is facilitated either by direct aortic cannulation or by cannulation of peripheral arteries, such as the carotid artery and/or femoral arteries. In some embodiments, the pulsatile perfusion associated with the heptic arterial flow is established via a pump.

In some embodiments, portal venous flow is achieved via constant-pressure perfusion at a second fluidic connection of the system with the cadaveric material. In some embodiments, the second fluidic connection is achieved by cannulation of the portal vein, thereby facilitating flow into the cadaveric liver. In some such embodiments, perfusion of the portal vein is facilitated either by direct cannulation or by cannulation of a tributary, such as the inferior mesenteric vein. In some embodiments, the constant-pressure perfusion associated with the portal venous flow is established through gravity-induced pressurized flow.

In some embodiments, heptic venous flow is an outflow of fluid from the liver at a third fluidic connection of the system with the cadaveric material. In some embodiments, the third fluidic connection is achieved by cannulation. In some such embodiments, the outflow is redirected to a holding tank, such as a supply tank or another tank of the present invention.

FIGS. 1-2 show an embodiment of a liver perfusion system 100 connected with a cadaveric liver, the system incorporating a first fluid reservoir 110 connected to a first conduit that is fluidically connected to the aorta 22 via a first cannula 182 in a configuration so as to direct a perfusion fluid 112 into the hepatic artery 24. In the embodiment shown, a pulsatile pump 140 is positioned along a length of the first conduit, thereby splitting the first conduit into first 120 and second 130 portions, the first portion 120 being positioned between the first reservoir 110 and the pump 140, and the second portion 130 being positioned between the pump 140 and the first cannula 182. In some embodiments, the first reservoir 110 houses a volume of oxygenated or red colored perfusion fluid 112, and the pump 140 is configured to direct the oxygenated or red colored perfusion fluid 112 from the first reservoir 110, through the first conduit and the first cannula 182, towards the hepatic artery 24 via pulsatile flow.

In the embodiment shown in FIGS. 1-2, a second fluid reservoir 150 is fluidically connected to a second conduit 160, which is fluidically connected to the portal vein 26 via a second cannula 184. In the embodiment shown, the second fluid reservoir 150 is positioned at an elevation above the liver 20 so as to put passive gravity feed pressure on the portal vein 26. In some embodiments, the second fluid reservoir 150 houses a volume of deoxygenated or dark blue colored perfusion fluid 152 that is passively supplied from the second fluid reservoir 150, through the second conduit 160 and the second cannula 184, to the portal vein 26.

In the embodiment shown, a third cannula 186 is fluidically connected to the inferior vena cava 28 and to an outflow, third conduit 170, which is also fluidically connected to the second reservoir 150. In the configuration shown, fluid from the inferior vena cava 28 passively drains into the second fluid reservoir 150. In other configurations, the outflow conduit 170 is configured and positioned such that the inferior vena cava 28 does not drain into the second fluid reservoir. In other embodiments, an outflow cannula 186 and conduit 170 is not included.

In some embodiments, in order to manage hepatic venous outflow into the inferior vena cava, gravity-pressurized cannulation of the jugular or femoral veins is also utilized. In some embodiments, to avoid excessive hepatic congestion, the internal jugular vein is drained into a drain or collection chamber, allowing for the replication of physiological hepatic vein pressures and flow away from the liver, while mitigating liver congestion.

In some embodiments, the hepatic artery is perfused by cannulating either the carotid artery or the aorta to direct flow specifically into the hepatic artery. In some embodiments, this can be accomplished by inserting a cannula into the carotid artery and pressurizing the entire aortic arch or aorta. In alternative embodiments, a lengthy cannula can be guided from the carotid artery into the visceral aorta at the level of the celiac artery, ensuring directed flow into the hepatic artery via the celiac artery route. Hepatic flow demonstrates pulsatile characteristics, and accordingly, in some embodiments of the present invention, flow of perfusion fluid into the hepatic artery is propelled by a piston pump. In embodiments, a pump is connected to the artery via cannula, and there is an incorporated Y adaptor with or without a pressure pop-off valve connected to a reservoir that contains blood exerting back pressure. Such Y configuration assures that any excess pressure from the pump to the artery is relieved back to the reservoir. In an exemplary embodiment, the perfusion fluid supplied from the reservoir connected to the artery has oxygenated (red) blood or red colored fluid, which is used to perfuse the hepatic artery.

For surgical simulation involving the portal vein, it must be considered that portal venous flow does not have pulsation. Accordingly, in some embodiments of the present invention, to mimic portal venous flow, cannulation of the portal vein is conducted through either laparotomy or laparoscopy. In exemplary embodiments, portal venous cannulation is targeted to the middle mesenteric vein or the portal vein proper at the porta hepatis. In exemplary embodiments, perfusion fluid supplied from a reservoir connected to the vein comprises deoxygenated (blue) blood or dark blue colored fluid, which is directed into the portal vein via a reservoir positioned at an elevated level to establish the desired portal pressure.

In some embodiments, the hepatic veins, like the portal vein, undergo pressurization. In some such embodiments, pressurization of the heptic veins is achieved by cannulating either the femoral or jugular veins, or both simultaneously. In some embodiments, pressure is induced by an elevated reservoir containing deoxygenated blood or dark blue colored perfusion fluid.

In embodiments, for both the hepatic vein and portal vein, the fluid pressure is determined by the height of the reservoir relative to the liver and pressure can be adjusted by adjusting the height of the fluid reservoir. In an alternative embodiment, an adjustable pressure-controlled pump is used to adjust the back pressure rather than relying on the elevation of the fluid reservoir.

### Thoracic Surgery Model

FIG. 3 shows an exemplary embodiment of a thoracic surgical simulation system 200 of the present invention, the embodiment shown in a configuration having a plurality of fluidic connections between the system of the present invention and the cadaveric material. In view of challenges associated with the anatomy of the pulmonary artery, venous system, and human thorax generally, this embodiment of the present invention provides selective perfusion and cannulation techniques for precise control over thoracic perfusion.

In an exemplary embodiment, the chest of a cadaver is harvested with or without the head and neck. Additionally, the arms may be severed, and the lower half of the body may be divided below the diaphragm, if needed to preserve those tissues for further use.

An exemplary embodiment includes a system and method for thoracic organ harvest and preservation in which the cadaveric heart 30 and lungs 32 are removed as a single unit and placed within a synthetic chest wall structure 290 to reduce the amount of donor tissue required for transportation and use. In embodiments, the synthetic chest wall 290 provides structural support, maintains anatomical positioning, and facilitates procedural access.

FIG. 3 shows an embodiment of a thoracic perfusion system 200 connected with cadaveric organs, the embodiment shown incorporating a first fluid reservoir 210 connected to a first conduit that is fluidically connected to the pulmonary artery via a first cannula. In the embodiment shown embodiment, a pump 240 is fluidically connected to the first reservoir 210 via the first conduit, with the pump being positioned in line with the first conduit such that the first conduit is split into a first 220, which is positioned between the first reservoir 210 and the pump 240, and a second portion 230, which is positioned between the pump 240 and the first cannula. In some embodiments, the first reservoir 210 houses a volume of deoxygenated or dark blue colored perfusion fluid 212, and the pump 240 is configured to supply the pulmonary artery with the deoxygenated or dark blue colored perfusion fluid 212 from the first reservoir 210 through the first conduit, through the first cannula, and into the pulmonary artery. Once the pulmonary artery is supplied with deoxygenated or dark blue colored perfusion fluid 212, the pump 240 is configured to repeatedly pressurize and release the pulmonary artery, with no additional flow of perfusion fluid 212.

In embodiment shown in FIG. 3, a second fluid reservoir 250 is fluidically connected to a second conduit 260, which is fluidically connected to the left atrium via a second cannula. In this embodiment, the second fluid reservoir 250 is positioned at an elevation above the heart 30 and lungs 32 so as to put passive gravity feed pressure on the left atrium and connected veins. The second fluid reservoir 250, in this embodiment, is configured for housing a volume of oxygenated or red colored perfusion fluid 252 which is passively supplied from the second fluid reservoir 250 through the second conduit 260, through the second cannula, to the left atrium and then veins. In the embodiment shown in FIG. 3, a third cannula is fluidically connected to a lower part of the left atrium and to an outflow, third conduit 270, which is also fluidically connected to the second reservoir 250. In this configuration, fluid from the heart 30 and lungs 32 passively drains into the second fluid reservoir 250. Nevertheless, in some embodiments, such an outflow cannula and conduit 270 is not included.

In embodiments, to mimic pulmonary circulation, the thoracic cavity of a human donor is utilized. In such embodiments, the thorax is kept intact and positioned on a molded platform that can stabilize the chest in a decubitus position. In an exemplary embodiment, the molded platform collects any lost fluid and, in some embodiments, is configured to return the fluid back to a fluid reservoir using a pump such as an impeller pump or alternative drainage and flow direction mechanism.

In embodiments, deoxygenated blood or a dark blue colored perfusion fluid is pumped using a piston pump into the pulmonary artery. In some embodiments, a cannula into the pulmonary artery is adapted with a Y connector. In some embodiments, such a Y connection is fitted with a pop-off valve. In embodiments, such Y connection directs blood back to the base of the elevated blood fluid reservoir creating a back pressure. In some embodiments, pulsatile flow into the pulmonary artery is achieved using a piston pump, with pressure relief occurring between cycles by draining through the same pulmonary artery cannula through the Y connector back to a reservoir. In such embodiments, this dual action maintains optimal pressure, preventing over pressurization and eliminating the necessity for perfusion fluid to traverse the lungs to reach the pulmonary veins.

In embodiments, the main pulmonary artery is cannulated to direct flow toward the pulmonary valve, or alternatively in the antegrade direction into the main pulmonary artery or separately into each pulmonary artery.

In embodiments, the pulmonary veins are perfused by cannulating the left atrium, through the left atrial appendage but avoiding the pulmonary veins so as not to interfere with the conduct of the operation.

In embodiments, the fluid pressure in the pulmonary veins is determined by the height of the reservoir relative to the lungs and can be adjusted by adjusting the height of the fluid reservoir. In an alternative embodiment, an adjustable pressure-controlled pump is used to adjust the back pressure rather than relying on the elevation of the fluid reservoir.

In embodiments, to reduce pulmonary congestion, the pulmonary veins are drained through a cannula inserted via the left atrial appendage, left atrium, or left ventricle, allowing continuous outflow and minimizing lung edema. Such an approach optimizes organ preservation, enhances usability for surgical training and research, and improves transport efficiency.

In an embodiment, an endotracheal tube is placed through the trachea. This is connected to a ventilator, or hand-bag ventilation is used, to mimic ventilation of the lung. Such ventilation reproduces the respiratory movements from the contralateral lung encountered during surgery for accurate surgical simulation.

This innovative approach, combined with advanced circulation reconstitution techniques, effectively mitigates lung parenchymal swelling, thus preserving the functionality of the model. Furthermore, the present system and method offers significant utility in the advancement and simulation of robotic-assisted lung resection procedures.

### Head and Neck Model

FIG. 4 shows an exemplary embodiment of a head and neck surgical simulation system 300 of the present invention, the embodiment shown in a configuration having a plurality of fluidic connections between the system of the present invention and the cadaveric material. In view of challenges associated with the anatomy of the vasculature of the head 40 and neck 42, this embodiment of the present invention provides selective perfusion and cannulation techniques for precise control over head and neck perfusion.

In an exemplary embodiment of a head and neck model 300, the circulatory system of the head is duplicated to facilitate neurological and otolaryngological surgeries. In an embodiment, the neck is detached at the base near the c7-6 vertebra. Nevertheless, in other embodiments, the head and/or neck can be detached at any other position to simulate head and/or neck surgery.

FIG. 4 shows an embodiment of a head and neck perfusion system 300 connected with a cadaveric neck and head, the embodiment shown incorporating a first fluid reservoir 310 connected to a first conduit that is fluidically connected to the carotid arteries 44 via one or more cannulas. In the embodiment shown, a pump 340 is fluidically connected to the first reservoir 310 and the first conduit, the pump being positioned in line with the first conduit such that the first conduit is split into a first portion 320, which is positioned between the first reservoir 310 and the pump 340, and a second portion 330, which is positioned between the pump 340 and the one or more cannulas. In the embodiment shown, the second portion 330 of the first conduit is split into two branches, each configured to be cannulated to a carotid artery 44. In other embodiments, the second portion 330 of the first conduit includes just one branch. In some embodiments, the first reservoir 310 houses a volume of oxygenated or red colored perfusion fluid 312, and the pump 340 is configured to direct the oxygenated or red colored perfusion fluid 312 from the first reservoir 310 through the first conduit, and pressurize the carotid arteries 44 with perfusion fluid 312.

In the embodiment shown in FIG. 4, a second fluid reservoir 350 is fluidically connected to a second conduit 360, which is fluidically connected to the jugular veins 46. The second conduit 360 may or may not be split into two branches, each configured to be cannulated to a jugular vein 46. The second fluid reservoir 350 is positioned at an elevation above the head 40 and neck 42 so as to put passive gravity feed pressure on the jugular veins 46. The second fluid reservoir 350, in this embodiment, is configured for housing a volume of deoxygenated or dark blue colored perfusion fluid 352 which is passively supplied from the second fluid reservoir 350 through the second conduit 360, and into the jugular veins 46. In the embodiment shown in FIG. 4, the vertebral arteries 48 are allowed to drain freely into a collection chamber or drain 372. In some embodiments, the fluid drained into the collection chamber or drain 372 may be supplied to the second fluid reservoir 350 via a third conduit 370 and pump or alternative drainage and flow mechanism. In other embodiments, there is no recirculation from a collection chamber or drain 372 into the second reservoir 350.

In an exemplary embodiment, the head is positioned within a molded container designed for stabilization and further configured to collect any fluid leakage and, in some embodiments, redirect it into a reservoir via a pump such as an impeller motor pump or alternative drainage and flow mechanism.

In embodiments, a pumping mechanism is linked to the head through cannulas affixed to the carotid arteries bilaterally at the neck. In embodiments, the vertebral arteries are identified and ligated to prevent fluid loss. In an embodiment, perfusion fluid is directed from a fluid reservoir into the cannula and into the carotid artery vid a piston pump pulsatile flow. In exemplary embodiments, these cannulas are fitted with Y connectors. In such embodiments, the Y connector may be adapted with a pop-off valve or directed back to the elevated reservoir to allow for back pressure. In an alternative embodiment, an adjustable pressure-controlled pump is used to adjust the back pressure rather than relying on the elevation of the reservoir.

In an embodiment, head and neck cannulation is achieved through bidirectional pulsatile flow directed to one or both carotid arteries. In an embodiment, jugular vein pressurization is performed passively using gravity, with the option to cannulate one or both jugular veins. In an embodiment, to prevent congestion, the vertebral arteries are left open, allowing drainage from the head.

In further embodiments, the head is positioned within a stabilization well that also functions as a fluid collection chamber or drain. In embodiments, such chamber includes a receptacle that collects drained fluid and returns it to the primary reservoir, facilitating recirculation to the pump.

### Extremity Model

FIG. 5 shows a further exemplary embodiment of the present invention pertaining to the use of donor tissue, organs, and extremities, the embodiment shown in a configuration having a plurality of fluidic connections between the system of the present invention and the cadaveric material. While full-body perfusion and its benefits have previously been described in detail, when the study of specific organs or extremities is required, optimal utilization of a donor is achieved by isolating the necessary component(s) rather than using the entire body. When a specific component is utilized, certain vascular structures or conduits that are no longer available must be replaced with synthetic materials. Accordingly, the embodiment of the present invention shown in FIG. 5 provides selective perfusion techniques incorporating synthetic vasculature for precise control over perfusion of human extremities, such as human arm(s) and/or leg(s). The connection between the synthetic substitutes and the remaining biological structures ensures functional perfusion and maintains anatomical integrity.

FIG. 5 shows an embodiment of a human extremity(ies) perfusion system 400. The system 400 includes a first fluid reservoir 410 fluidically connected to a conduit 420 which fluidically connects to a synthetic aorta 510 and connected synthetic arteries which fluidically connect to cadaverous arteries 64, 66 within human extremities via connectors 530, such as a polyester graft bridge or internal diameter connector. In this embodiment, a pump 440 is fluidically connected to the first reservoir 410 and conduit 420 in line with the conduit 420 and fluidically connects to the synthetic aorta 510 either directly or through another conduit extension. In some embodiments, the first reservoir 410 houses a volume of oxygenated or red colored perfusion fluid 412, and the pump 440 is configured to direct the oxygenated or red colored perfusion fluid 440 from the first reservoir 410 through the conduit 420, through the synthetic aorta 510, and into the extremity arteries 64, 66.

In the embodiment shown in FIG. 5, a second fluid reservoir 450 is fluidically connected to a synthetic vena cava 520 and connected synthetic veins, either directly or through a second conduit 460, and the synthetic vena cava 520 and connected synthetic veins fluidically connect to cadaverous veins 68, 72 within human extremities via connectors 530, such as a polyester graft bridge or internal diameter connector. The second fluid reservoir 450 is positioned at an elevation above the cadaverous arms 62 and/or legs 60 and/or other extremities so as to put passive gravity feed pressure on the extremity veins 68, 72. The second fluid reservoir 450, in this embodiment, is configured for housing a volume of deoxygenated or dark blue colored perfusion fluid 452 which is passively supplied from the second fluid reservoir 450 through the synthetic vena cava 520, and into the extremity veins 68, 72. In some embodiments, each of the cadaverous extremities 60, 62 may be configured to fluidically connect to a collection chamber or drain 472, via cannula and drain conduit 470 or alternative drainage means. In some embodiments with one or more drains 472, the collected fluid 452 may be circulated back to the second reservoir 450. Nevertheless, in some embodiments, such drain(s) or outflow cannula and conduit are not included.

In an exemplary embodiment, a polyester graft bridge is utilized to connect synthetic materials to vasculature of human extremities. In the study of endovascular procedures using a donor leg, perfusion is traditionally achieved by directly cannulating the proximal stump of the common femoral artery and vein. However, in cases where a more complete vascular system, including the iliac arteries and aortic bifurcation, is required, a synthetic aorta and iliac system may be introduced. In embodiments, access for the operator is obtained via a synthetic conduit representing the contralateral femoral artery. In embodiments, the ipsilateral synthetic iliac conduit is connected to a common femoral artery stump of donor tissue using a short bridge of polyester graft. In embodiments, such graft is anastomosed to the tissue common femoral artery and positioned over the distal end of the synthetic femoral artery. In embodiments, the graft is secured in place with a tie band or suture, ensuring a functional and stable connection. In embodiments, similar connection of synthetic materials is adapted for connection to vasculature of cadaverous arm(s) or other extremities or body parts.

In another exemplary embodiment, an internal diameter connector is utilized. In this embodiment, the synthetic vascular system is connected using an internal diameter connector. In this configuration, a connector is designed to fit within the inner diameter of the synthetic external iliac artery conduit. The connector is inserted into the tissue common femoral artery stump, creating a stable interface. A tie band or suture is then applied around the common femoral artery to cinch it securely around the connector, maintaining perfusion integrity. In embodiments, similar connection of synthetic materials is adapted for connection to vasculature of cadaverous arm(s) or other extremities or body parts.

Certain terminology will be used in the description for convenience in reference only and will not be limiting. For example, up, down, front, back, right, and left refer to the invention as orientated in the view being referred to. The words “inwardly” and “outwardly” refer to directions toward and away from, respectively, the geometric center of the aspect being described and designated parts thereof. Forwardly and rearwardly are generally in reference to the direction of travel, if appropriate. Additionally, anatomical terms are given their usual meanings. For example, proximal means closer to the trunk of the body, and distal means further from the trunk of the body. Said terminology will include the words specifically mentioned, derivatives thereof, and words of similar meaning.

As used in this specification and the appended claims, the singular forms “a”, “an”, and “the” include plural references unless the context clearly dictates otherwise. Thus, for example, a reference to “a method” includes one or more methods, elements, and/or steps of the type described herein and/or which will become apparent to those persons skilled in the art upon reading this disclosure and so forth.

As used in this specification and the appended claims, the use of the term “about” means a range of values including and within 15% above and below the named value, except for nominal temperature. For example, the phrase “about 3 mM” means within 15% of 3 mM, or 2.55-3.45, inclusive. Likewise, the phrase “about 3 millimeters (mm)” means 2.55 mm-3.45 mm, inclusive. When temperature is used to denote change, the term “about” means a range of values including and within 15% above and below the named value. For example, “about 5° C.,” when used to denote a change such as in “a thermal resolution of better than 5° C. across 3 mm,” means within 15% of 5° C., or 4.25° C.-5.75° C. When referring to nominal temperature, such as “about −50° C. to about +50° C.,” the term “about” means ±5° C. Thus, for example, the phrase “about 37° C.” means 32° C.-42° C.

Unless defined otherwise, all technical and scientific terms used herein have the same meaning as commonly understood by one of ordinary skill in the art to which this invention belongs. Although any systems, elements, methods and materials similar or equivalent to those described herein can be used in the practice or testing of the present invention, the preferred systems, elements, and methods and materials are now described. All publications mentioned herein are incorporated herein by reference to describe in their entirety.

“Substantially” means to be more-or-less conforming to the particular dimension, range, shape, concept, or other aspect modified by the term, such that a feature or component need not conform exactly. For example, a “substantially cylindrical” object means that the object resembles a cylinder but may have one or more deviations from a true cylinder. “Comprising,” “including,” and “having” (and conjugations thereof) are used interchangeably to mean including but not necessarily limited to, and are open-ended terms not intended to exclude additional, unrecited elements or method steps.

Changes may be made in the above methods, devices and structures without departing from the scope hereof. Many different arrangements of the various components depicted, as well as components not shown, are possible without departing from the spirit and scope of the present invention. Embodiments of the present invention have been described with the intent to be illustrative and exemplary of the invention, rather than restrictive or limiting of the scope thereof. Alternative embodiments will become apparent to those skilled in the art that do not depart from its scope. Specific structural and functional details disclosed herein are not to be interpreted as limiting, but merely as a representative basis for teaching one of skill in the art to employ the present invention in any appropriately detailed structure. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

It is also to be understood that the following claims are intended to cover all of the generic and specific features of the invention herein described, and all statements of the scope of the invention which, as a matter of language, might be said to fall therebetween.

Having thus described the invention, what is claimed as new and desired to be secured by Letters Patent is:

1. A perfusion system for selective perfusion of an organ system of a cadaver, the perfusion system comprising:
a first fluid reservoir for holding at least a portion of a first volume of a first perfusion fluid;
a first conduit fluidically connected to said first fluid reservoir, wherein said first conduit is configured to facilitate a first fluidic connection with said organ system;
a second fluid reservoir for holding at least a portion of a second volume of a second perfusion fluid; and
a second conduit fluidically connected to said second fluid reservoir, wherein said second conduit is configured to facilitate a second fluidic connection with said organ system.

2. The perfusion system of claim 1, wherein:
said second fluid reservoir is positioned at a first elevation that is higher than a second elevation of said organ system so as to provide constant-pressure supply of said second perfusion fluid at said second fluidic connection.

3. The perfusion system of claim 1, further comprising:
a first cannula secured to a distal end of said first conduit, said first cannula being configured to engage with the organ system so as to form the first fluidic connection; and
a second cannula secured to a distal end of said second conduit, said second cannula being configured to engage with the organ system so as to form the second fluidic connection.

4. The perfusion system of claim 1, further comprising:
a third conduit for facilitating a third fluidic connection with said organ system,
wherein said third conduit is configured to facilitate drainage of said second perfusion fluid from the organ system.

5. The perfusion system of claim 4, wherein said third conduit is fluidically connected to said second fluid reservoir so as to facilitate return of fluid to said second fluid reservoir.

6. The perfusion system of claim 1, comprising a pulsatile pump connected to said first fluid reservoir, said pump being configured to provide pulsatile pressure of said first perfusion fluid at the first fluidic connection.

7. The perfusion system of claim 1, further comprising the first and second volumes of the first and second perfusion fluids, respectively, wherein:
said first perfusion fluid is one of a first fluid type and a second fluid type;
said second perfusion fluid is the other of the first fluid type and the second fluid type;
said first fluid type comprises oxygenated blood or a red colored simulated blood fluid; and
said second fluid type comprises deoxygenated blood or a blue colored simulated blood fluid.

8. The perfusion system of claim 1, further comprising:
a collection chamber configured to collect drained first or second perfusion fluid from said organ system.

9. The perfusion system of claim 1, further comprising:
a molded platform configured to retain all or a portion of said organ system in an anatomically correct position.

10. The perfusion system of claim 1, wherein said organ system comprises a liver and related vasculature of said cadaver, wherein said first cannula is configured to engage with an aorta of said cadaver near a hepatic artery of said cadaver, thereby forming the first fluidic connection, and wherein said second cannula is configured to engage with a portal vein of said cadaver near said liver, thereby forming the second fluidic connection.

11. The perfusion system of claim 1, wherein said organ system comprises a thorax and related vasculature of said cadaver, wherein said first cannula is configured to engage with a pulmonary artery of said cadaver, thereby forming the first fluidic connection, and wherein said second cannula is configured to engage with a left atrium of said cadaver, thereby forming the second fluidic connection.

12. The perfusion system of claim 1, wherein:
said organ system comprises a head, neck and related vasculature of said cadaver.

13. The perfusion system of claim 1, wherein said organ system comprises one or more human extremities of said cadaver, wherein said first conduit comprises a synthetic aorta, and wherein said second conduit comprises a synthetic vena cava.

14. A method of selectively perfusing an organ system of a cadaver for surgical simulation, the method comprising:
providing a first fluid reservoir and a first conduit fluidically connected thereto;
filling said first fluid reservoir with a first volume of a first perfusion fluid;
fluidically connecting said first conduit with said organ system, thereby forming a first fluidic connection;
providing a second fluid reservoir and a second conduit fluidically connected thereto;
filling said second fluid reservoir with a second volume of a second perfusion fluid;
fluidically connecting said second conduit with said organ system, thereby forming a second fluidic connection;
directing flow of said first perfusion fluid from said first fluid reservoir, through said first conduit, towards said first fluidic connection; and
directing flow of said second perfusion fluid from said second fluid reservoir, through said second conduit, towards said second fluidic connection.

15. The method of claim 14, further comprising:
providing pulsatile supply of the first perfusion fluid at the first fluidic connection; and
providing a constant-pressure supply of said second perfusion fluid at said second fluidic connection.

16. The method of claim 15, further comprising positioning said second fluid reservoir at a first elevation that is higher than a second elevation of said organ system.

17. The method of claim 16, further comprising fluidically connecting a third conduit with said organ system, thereby forming a third fluidic connection that facilitates drainage of said second perfusion fluid from the organ system.

18. The method of claim 17, further comprising fluidically connecting the third conduit to the second fluid reservoir so as to facilitate return of fluid to the second fluid reservoir.

19. The method of claim 14, further comprising:
fluidically connecting a pulsatile pump to the first fluid reservoir; and
providing pulsatile pressure of the first perfusion fluid at the first fluidic connection.

20. The method of claim 19, further comprising:
ligating or otherwise closing off blood vessels of said cadaver not to be used for surgical simulation.
